(19) United States
(12) Patent Application Publication
(10) Pub. No.: US 2009/0049943 A1
(43) Pub. Date: Feb. 26, 2009

(54) PROCESS FOR PREVENTION OF UNINTENTIONAL GEAR SHIFTING FROM A NON-FRICTION LOCKED POSITION IN A TRANSMISSION

(75) Inventors: Franz HORNEFFER, Meckenbeuren (DE); Bernd Zanglein, Ravensburg (DE); Stephane Klein, Kressbronn (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/188,415

(22) Filed: Aug. 8, 2008

(30) Foreign Application Priority Data
Aug. 24, 2007 (DE) 10 2007 040 039.1

(51) Int. Cl. G05G 5/08; G06F 17/00

(52) U.S. Cl. 74/473.24; 701/62

(57) ABSTRACT

A process for the prevention of unintentional gear shifting from a non-friction locked position of a transmission is proposed, which is comprised by an electrical or electronic gear shift control and a friction-locked gear shift or selector device, within the scope of which the requested friction-locked position detected by the electrical or electronic gear shift control is outputted and is displayed to the driver by way of a position display during position shifting from a non-friction locked position, at the latest when the friction-locked gear shift or selector device has reached a position or a range within which it can remain in an automatic lockup, whereupon this position is implemented in the transmission.

This application claims priority from German Application Serial No. DE 10 2007 040 039.1 filed Aug. 24, 2007.

### FIELD OF THE INVENTION

The invention concerns a process for preventing of unintentional gear shifting from a non-friction locked position of a transmission, comprising an electrical or electronic gear shift control and a friction-locked gear shift or selector device.

### BACKGROUND OF THE INVENTION

From the prior art are known automatic transmissions for motor vehicles, which have an electrical or electronic gear shift control (“shift by wire”), wherein no mechanical linkage is provided between the gear shift or selector device and the transmission. The driver's requests inputted by way of a friction-locked gear shift or selector device, which is usually configured as a stepping switch or rotary switch, are transmitted to the transmission or to the transmission control by way of an electrical or electronic interface located between the gear shift or selector device and the automatic transmission, where the shifting operation is implemented hydraulically or electrically by way of actuators.

The applicant's unpublished application DE 10 2007 005 400 discloses a process for the operation of at least one automatic transmission having one electrical gear shift control and a power train of a motor vehicle comprising a drive unit. The inputted driver's requests are transmitted to a slotted disc of the automatic transmission by a gear selector lever, which has locked or stable gear selector lever positions (P, R, N, D), via an electrical or electronic interface connected between the gear selector lever and the automatic transmission in such a manner that the slotted disc assumes a position, which is dependent on the actuation of the gear selector lever.

A driver's request, which is used by a transmission control to control the function of the automatic transmission, is determined at the slotted disc of the automatic transmission with the aid of a position sensor of the automatic transmission, which is preferably configured as a digital position sensor.

Situations can when shifting gears in an automatic transmission by way of a friction-locked gear shift or selector device from a non-friction locked position, that is, from the position P or the position N in which the gear shift or selector device, which is configured as a stepping switch or rotary switch, can stop at an unstable middle position (vertex) between two locked or stable positions.

In this middle position, the position display is blanked according to the prior art, whereupon the previous position may be retained or the power flow may be interrupted in the transmission depending on the direction of motion of the actuation.

In this situation, when the locked gear shift or selector device unexpectedly moves independently into a drive setting, for example due to a jolt, or in the case of an early release of the shifting or gear selector device, this motion can lead to an unexpected vehicle motion which will be surprising for the driver. This problem will be explained in detail below with reference to FIG. 1.

It is an object of the invention to disclose a process for the prevention of unintentional gear shifting from a non-friction locked position in a transmission comprising an electrical or electronic gear shift control and a locked gear shift or selector device, so that the disadvantages known from the prior art are prevented by way of its implementation.

### SUMMARY OF THE INVENTION

Accordingly, in the case of a gear shift from a non-friction locked position, it is proposed to display to the driver and also implement in the transmission the requested friction-locked position detected by the electrical or electronic gear shift control at the latest when the friction-locked gear shift or selector device has reached a position or a range within which it can remain in automatic locking by way of a position display.

The mentioned automatic locking usually occurs within the range of the middle position or vertex between two shift positions of the gear shift or selector device.

Within the scope of a first embodiment of the invention, the driver's request corresponding to a friction-locked position, which is detected by the electrical or electronic gear shift control no later than when the friction-locked gear shift or selector device has reached a position or a range within which it can remain in automatic lockup by way of a position is announced to the driver, whereupon the transmission is in correspondence shifted corresponding to this position.

The driver is made aware by way of this procedure that the requested friction-locked position has been engaged. If the gear shift or selector device jumps from the middle position into the friction-locked position, this does not advantageously cause a surprising shift in this kind of situation. In the event that the gear shift or selector jumps back into the non-friction locked position, then the power flow in the transmission will be interrupted so that no unexpected vehicle motion can occur.

According to another embodiment of the invention, the friction-locked position will already be displayed and the transmission will be shifted accordingly, as soon as the driver's request is detected by the electrical or electronic gear shift control even before the middle position is reached.

Yet another embodiment of the invention proposes to use a modeling of the friction-locked gear shift or selector device, taking into consideration the mechanical tolerances as well as the tolerances in the signals of electrical or electronic shift actuation in order to determine the ranges within which the friction-locked gear shift or selector device can stop and then, at the latest when the locked gear shift or selector device has reached one of these ranges, to output the friction locked position, display the position to the driver and implement the position in the transmission.

According to the invention, it is provided that the electrical or electronic gear shift control is designed in such a way that the driver's request is detected before the middle position is reached, or before the critical ranges are reached.

### BRIEF DESCRIPTION OF THE DRAWINGS

The invention will now be described, by way of example, with reference to the accompanying drawings in which;

FIG. 1 shows a diagram to illustrate the mode of operation for position shifting in a transmission according to the prior art, comprising an electrical or an electronic gear shift control and a friction-locked gear shift or selector device, and

FIG. 2 shows a diagram to illustrate the process according to the invention.

### DETAILED DESCRIPTION OF THE INVENTION

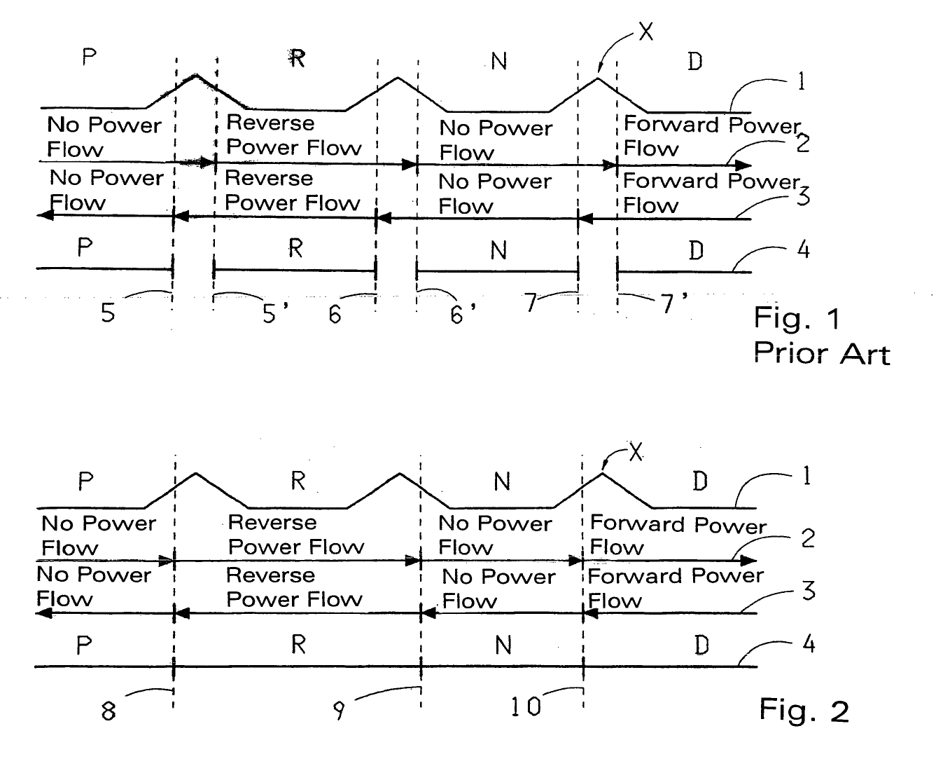

In FIGS. 1 and 2, a curve 1 represents the force applied by the driver or determined by the system on a friction-locked gear shift or selector device, for example a rotary switch, wherein the positions P, R, N and D of an automatic transmission are shown as stable positions. A curve 2 below the positions P, R, N, D, clarifies the respective actual driving position implemented in the transmission after actuation of the gear shift or selector device in the indicated direction of motion for a gear shift from P to R, from R to N and from N to D. A curve 3 similarly illustrates the driving position set in the transmission for a gear shift from D to N, from N to R and from R to P.

As is indicated by a curve 4 in the system, according to the state of the art illustrated in FIG. 1, the position display is always blanked as long as the gear shift or selector device is located within the regions between dashed lines 5 and 5′, 6 and 6′ or 7 and 7′, respectively, with a gear shift from D to N, N to R and R to P, and also for a shift from N to D, R to N and P to R. This is supposed to ensure that the driver does not receive any misleading or even erroneous information about the state of the transmission. These ranges between the dashed lines 5, 5′ and 6, 6′ and 7, 7′ denote the vertices of the position change, a region in which the gear shift or selector device comes or can come into a mechanical automatic lockup.

The process according to the invention will be explained below based on one position shift from N to D.

Regarding FIG. 1, an increasing amount of force must be applied by the driver in order to shift gears so that starting at a specific point X, the vertex, the gear shift or selector device should jump in the direction D, because a force determined by the system acts on the device (this is illustrated by the negative slope of curve 1 starting at this point). Before this point, the gear shift or selector device jumps automatically back to the starting position when released.

In the practice, as a consequence of the friction effects and tolerances, a slightly curved profile is adopted instead of the vertex so that the gear shift or selector device can stop in a middle position within this critical region, which corresponds to the curved profile (automatic lockup). As is evident in FIG. 1, this middle position or the critical region for a gear shift from N to D, is located within range between lines 7, 7′, so that the position N is retained and the position display is blanked. As previously explained, the gear shift or selector device can jump from this automatic lockup in the direction D due to an external influence, such as closing a vehicle door, whereby the transmission will be shifted into the undesirable position D.

In order to prevent this problem, the inventive propess to output's friction-locked position to the position display and also implement it in the transmission no later than when the friction-locked gear shift or selector device comes within the range of the automatic lockup. As prerequisite for this, the driver's request must have already been detected by the electronic system. For this purpose, the electrical or electronic gear shift control is designed such that the driver's request is detected before the middle positions or the critical ranges are reached.

This position is defined in FIG. 2 by way of a dashed line 10 for gear shift from N to D. In the embodiment, this position is located in front of the vertex X, seen in the direction of motion of the gear shift or selector device and can alternatively coincide with these two positions.

Dashed lines 8 and 9 similarly represent, in FIG. 2, the position shifts from P to R and from R to N, each of which mark the transition from one driving position into another.

The transmission position display is not blanked when the gear shift or selector device is actuated to implement a change in position, contrary to the prior art, and the driver always has a clear view of the position display, which always corresponds to the actual driving position engaged in the transmission.

The concept, according to the invention, ensures that the friction-locked gear shift or selector device is always secured so that an unexpected position shift from a non-friction locked position is prevented. In the event of a position shift from a non-friction locked position into a friction-locked position, always just before the vertex of the motion of the gear shift or selector device is reached, the driving position selected by the driver will be shifted in the transmission and this will also be announced on the position display. For this reason, if the driver releases the gear shift or selector device just before the vertex, this gear shift or selector device will jump back into a non-friction locked driving position, which represents an essential safety feature.

If the driver releases the gear shift or selector device at the vertex, the gear shift or selector device can jump into both driving positions, that is, the non-friction locked driving position and the friction-locked driving position. In contrast with the prior art, the driver will not be surprised by a jump into the friction locked driving position, since the driver will already be informed about this via the position display.

Process for Prevention of Unintentional Gear Shifting from a Non-Friction Locked Position in a Transmission

The invention concerns a process for preventing of unintentional gear shifting from a non-friction locked position of a transmission, comprising an electrical or electronic gear shift control and a friction-locked gear shift or selector device, according to the preamble of patent claim 1.

From the prior art are known automatic transmissions for motor vehicles, which have an electrical or electronic gear shift control (“shift by wire”), wherein no mechanical linkage is provided between the gear shift or selector device and the transmission. The driver's requests inputted by way of a friction-locked gear shift or selector device, which is usually configured as a stepping switch or rotary switch, are transmitted to the transmission or to the transmission control by way of an electrical or electronic interface located between the gear shift or selector device and the automatic transmission, where the shifting operation is implemented hydraulically or electrically by way of actuators.

The applicant's unpublished application DE 10 2007 005 400 discloses a process for the operation of at least one automatic transmission having one electrical gear shift control and a power train of a motor vehicle comprising a drive unit. The inputted driver's requests are transmitted to a slotted disc of the automatic transmission by a gear selector lever, which has locked or stable gear selector lever positions (P, R, N, D), via an electrical or electronic interface connected between the gear selector lever and the automatic transmission in such a manner that the slotted disc assumes a position, which is dependent on the actuation of the gear selector lever.

A driver's request, which is used by a transmission control to control the function of the automatic transmission, is determined at the slotted disc of the automatic transmission with the aid of a position sensor of the automatic transmission, which is preferably configured as a digital position sensor.

Situations can when shifting gears in an automatic transmission by way of a friction-locked gear shift or selector device from a non-friction locked position, that is, from the position P or the position N in which the gear shift or selector device, which is configured as a stepping switch or rotary switch, can stop at an unstable middle position (vertex) between two locked or stable positions.

In this middle position, the position display is blanked according to the prior art, whereupon the previous position may be retained or the power flow may be interrupted in the transmission depending on the direction of motion of the actuation.

In this situation, when the locked gear shift or selector device unexpectedly moves independently into a drive setting, for example due to a jolt, or in the case of an early release of the shifting or gear selector device, this motion can lead to an unexpected vehicle motion which will be surprising for the driver. This problem will be explained in detail below with reference to FIG. 1.

It is an object of the invention to disclose a process for the prevention of unintentional gear shifting from a non-friction locked position in a transmission comprising an electrical or electronic gear shift control and a locked gear shift or selector device, so that the disadvantages known from the prior art are prevented by way of its implementation.

This object is attained by way of the features of patent claim 1. Additional embodiments and advantages of the invention are indicated in the dependent claims and in the subsequent description.

Accordingly, in the case of a gear shift from a non-friction locked position, it is proposed to display to the driver and also implement in the transmission the requested friction-locked position detected by the electrical or electronic gear shift control at the latest when the friction-locked gear shift or selector device has reached a position or a range within which it can remain in automatic locking by way of a position display.

The mentioned automatic locking usually occurs within the range of the middle position or vertex between two shift positions of the gear shift or selector device.

Within the scope of a first embodiment of the invention, the driver's request corresponding to a friction-locked position, which is detected by the electrical or electronic gear shift control no later than when the friction-locked gear shift or selector device has reached a position or a range within which it can remain in automatic lockup by way of a position is announced to the driver, whereupon the transmission is in correspondence shifted corresponding to this position.

The driver is made aware by way of this procedure that the requested friction-locked position has been engaged. If the gear shift or selector device jumps from the middle position into the friction-locked position, this does not advantageously cause a surprising shift in this kind of situation. In the event that the gear shift or selector jumps back into the non-friction locked position, then the power flow in the transmission will be interrupted so that no unexpected vehicle motion can occur.

According to another embodiment of the invention, the friction-locked position will already be displayed and the transmission will be shifted accordingly, as soon as the driver's request is detected by the electrical or electronic gear shift control even before the middle position is reached.

Yet another embodiment of the invention proposes to use a modeling of the friction-locked gear shift or selector device, taking into consideration the mechanical tolerances as well as the tolerances in the signals of electrical or electronic shift actuation in order to determine the ranges within which the friction-locked gear shift or selector device can stop and then, at the latest when the locked gear shift or selector device has reached one of these ranges, to output the friction locked position, display the position to the driver and implement the position in the transmission.

According to the invention, it is provided that the electrical or electronic gear shift control is designed in such a way that the driver's request is detected before the middle position is reached, or before the critical ranges are reached.

The invention will be explained in greater detail below with reference to the enclosed figures, wherein:

FIG. 1 shows a diagram to illustrate the mode of operation for position shifting in a transmission according to the prior art, comprising an electrical or an electronic gear shift control and a friction-locked gear shift or selector device, and

FIG. 2 shows a diagram to illustrate the process according to the invention.

In FIGS. 1 and 2, a curve 1 represents the force applied by the driver or determined by the system on a friction-locked gear shift or selector device, for example a rotary switch, wherein the positions P, R, N and D of an automatic transmission are shown as stable positions. A curve 2 below the positions P, R, N, D, clarifies the respective actual driving position implemented in the transmission after actuation of the gear shift or selector device in the indicated direction of motion for a gear shift from P to R, from R to N and from N to D. A curve 3 similarly illustrates the driving position set in the transmission for a gear shift from D to N, from N to R and from R to P.

As is indicated by a curve 4 in the system, according to the state of the art illustrated in FIG. 1, the position display is always blanked as long as the gear shift or selector device is located within the regions between dashed lines 5 and 5′, 6 and 6′ or 7 and 7′, respectively, with a gear shift from D to N, N to R and R to P, and also for a shift from N to D, R to N and P to R. This is supposed to ensure that the driver does not receive any misleading or even erroneous information about the state of the transmission. These ranges between the dashed lines 5, 5′ and 6, 6′ and 7, 7′ denote the vertices of the position change, a region in which the gear shift or selector device comes or can come into a mechanical automatic lockup.

The process according to the invention will be explained below based on one position shift from N to D.

Regarding FIG. 1, an increasing amount of force must be applied by the driver in order to shift gears so that starting at a specific point X, the vertex, the gear shift or selector device should jump in the direction D, because a force determined by the system acts on the device (this is illustrated by the negative slope of curve A starting at this point). Before this point, the gear shift or selector device jumps automatically back to the starting position when released.

In the practice, as a consequence of the friction effects and tolerances, a slightly curved profile is adopted instead of the vertex so that the gear shift or selector device can stop in a middle position within this critical region, which corresponds to the curved profile (automatic lockup). As is evident in FIG. 1, this middle position or the critical region for a gear shift from N to D, is located within range between lines 3, 3′, so that the position N is retained and the position display is blanked. As previously explained, the gear shift or selector device can jump from this automatic lockup in the direction D due to an external influence, such as closing a vehicle door, whereby the transmission will be shifted into the undesirable position D.

In order to prevent this problem, the inventive propess to output's friction-locked position to the position display and also implement it in the transmission no later than when the friction-locked gear shift or selector device comes within the range of the automatic lockup. As prerequisite for this, the driver's request must have already been detected by the electronic system. For this purpose, the electrical or electronic gear shift control is designed such that the driver's request is detected before the middle positions or the critical ranges are reached.

This position is defined in FIG. 2 by way of a dashed line 10 for gear shift from N to D. In the embodiment, this position is located in front of the vertex X, seen in the direction of motion of the gear shift or selector device and can alternatively coincide with these two positions.

Dashed lines 8 and 9 similarly represent, in FIG. 2, the position shifts from P to R and from R to N, each of which mark the transition from one driving position into another.

The transmission position display is not blanked when the gear shift or selector device is actuated to implement a change in position, contrary to the prior art, and the driver always has a clear view of the position display, which always corresponds to the actual driving position engaged in the transmission.

The concept, according to the invention, ensures that the friction-locked gear shift or selector device is always secured so that an unexpected position shift from a non-friction locked position is prevented. In the event of a position shift from a non-friction locked position into a friction-locked position, always just before the vertex of the motion of the gear shift or selector device is reached, the driving position selected by the driver will be shifted in the transmission and this will also be announced on the position display. For this reason, if the driver releases the gear shift or selector device just before the vertex, this gear shift or selector device will jump back into a non-friction locked driving position, which represents an essential safety feature.

If the driver releases the gear shift or selector device at the vertex, the gear shift or selector device can jump into both driving positions, that is, the non-friction locked driving position and the friction-locked driving position. In contrast with the prior art, the driver will not be surprised by a jump into the friction locked driving position, since the driver will already be informed about this via the position display.

1-3. (canceled)

4. A process for preventing unintentional gear shifting from a non-friction locked position in a transmission comprising one of an electrical or an electronic gear shift control and one of a friction-locked gear shift or a selector device, the process comprising the steps of:
outputting a requested friction-locked position detected by the one of the electrical or electronic gear shift control; and
displaying the requested friction-locked position to a driver, via a position display, during position shifting from the non-friction locked position, at the latest when the one of the friction-locked gear shift or the selector device has reached one of an other position or a range within which it remains in an automatic lockup, whereupon the other position is implemented in the transmission.

5. The process according to claim 4, wherein a driver's request, which corresponds to a friction-locked position, is detected by the one of the electrical or the electronic gear shift control at the latest before a middle position between a non-friction locked and a friction-locked position is reached, and is announced to the driver, whereupon the transmission is shifted corresponding to this position.

6. The process according to claim 5, wherein the display of the friction-locked position is outputted and the transmission is correspondingly shifted, as soon as the driver's request is recognized by the one of the electrical or the electronic gear shift control before the middle position is reached.

7. A process for preventing an unintentional gear shift in a transmission, which is in a non-friction locked position and includes an electrical gear shift control and a friction-locking gearshift, the process comprising the steps of:
detecting a driver requested friction-locked position with the electrical gear shift control;
outputting and displaying the driver requested friction-locked position to a driver with a position display during position shifting from the non-friction locked position and no later than when the friction-locked gearshift has achieved one of a position and a range in which the friction-locked gearshift is automatically lockable; and
engaging the transmission in the friction-locked position requested by the driver.

8. The process according to claim 7, further comprising the step of detecting the friction-locked position and displaying the friction-locked position, which was requested by the driver with the electrical gearshift control, before the electrical gearshift control reaches a middle position between a non-friction locked position and a friction-locked position; and
engaging the transmission in the friction-locked position requested by the driver.

9. The process according to claim 8, further comprising the step of displaying the friction-locked position, which was requested by the driver and correspondingly engaging the transmission in the friction-locked position, as soon as the friction-locked position requested by the driver is recognized by the electrical gear shift control before the middle position is reached.
